(19) United States
(12) Patent Application Publication
(10) Pub. No.: US 2019/0005920 A1
(43) Pub. Date: Jan. 3, 2019

(54) TERMIANL APPARATUS AND DISPLAY METHOD

(71) Applicant: Wuhan China Star Optoelectronics Technology Co., Ltd., Wuhan, Hubei (CN)

(72) Inventor: Qingcheng ZUO, Shenzhen, Guangdong (CN)

(73) Assignee: Wuhan China Star Optoelectronics Technology Co., L td., Wuhan, Hubei (CN)

(21) Appl. No.: 15/563,640

(22) PCT Filed: Jul. 26, 2017
(86) PCT No.: PCT/CN2017/094416

§ 371 Date: Oct. 2, 2017

(30) Foreign Application Priority Data
Jun. 30, 2017 (CN) 201710530463.2

(51) Int. Cl. G09G 5/14; G06F 3/01

(52) U.S. Cl. CPC G09G 5/14; G09G 2340/0407; G06F 3/013

(57) ABSTRACT

The present application provides a terminal apparatus, which comprises a sensor, a controller, and a display screen. The sensor is used to sense a focused area and a non-focused area on the display screen when the human eye or an observing device views the display screen. The controller is used to display a display content within the focused area at a first display resolution and to display a display content within the non-focused area at a second display resolution, based on a sensing result of the sensor, wherein the first display resolution is higher than the second display resolution. The present application further provides a display method, which is used to display an image on the display screen of the terminal apparatus.

### CROSS REFERENCE TO RELATED APPLICATIONS

The present application claims the priority benefit of application serial No. 201710530463.2, entitled “Terminal apparatus and display method”, filed on Jun. 30, 2017, which is incorporated herein by reference for all purposes and fully set forth herein.

### BACKGROUND OF THE APPLICATION

### Field of Application

The present application relates to the field of liquid crystal display, and more particularly to a terminal apparatus and display method.

### Description of Prior Art

Because of the better viewing experience, the large-size displays are increasingly becoming the mainstream technology. However, the size also increases the power consumption of the display, resulting in product heat, endurance deterioration.

### SUMMARY OF THE APPLICATION

In view of this, the present application provides a terminal apparatus and a display method.

A terminal apparatus comprises a sensor, a controller, and a display screen. The sensor is used to sense a focused area and a non-focused area on the display screen when the human eye or an observing device views the display screen. The controller is used to display a display content within the focused area at a first display resolution and to display a display content within the non-focused area at a second display resolution, based on a sensing result of the sensor, wherein the first display resolution is higher than the second display resolution.

Wherein the first display resolution is less than or equal to the pixel density of the display screen.

Wherein the controller that is used to display a display content within the focused area at the first display resolution and to display a display content within the non-focused area at a second display resolution comprises:

The controller receives an original display content, and determines a first display content portion corresponding to the focused area and a second display content portion corresponding to the non-focused area based on the original display content, adjusts a resolution of the first display content portion to the first display resolution and a resolution of the second display content portion to the second display resolution, and display the first display content portion with the first display resolution at the focused area on the display screen and the second display content portion with the second display resolution at the non-focused area on the display screen.

Wherein the controller that adjusts a resolution of the second display content portion to the second display resolution comprises:

The controller compresses an image data of the second display content portion to adjust the resolution of the second display content portion to the second display resolution; or the controller enlarges an image data of the second display content portion to adjust the resolution of the second display content portion to the second display resolution.

Wherein the controller that determines a first display content portion corresponding to the focused area and a second display content portion corresponding to the non-focused area based on the original display content comprises:

The controller adjusts the resolution of the original display content to be smaller than the pixel density and determines the first display content portion corresponding to the focused area and the second display content portion corresponding to the non-focused area based on the original display content after a resolution adjustment.

A display method, which comprises: a focused area and a non-focused area on the display screen is sensed when the human eye or an observing device views the display screen; a display content within the focused area at a first display resolution is controlled to display and a display content within the non-focused area at a second display resolution is controlled to display, based on a sensing result of the sensor. Wherein the first display resolution is higher than the second display resolution.

Wherein the first display resolution is less than or equal to the pixel density of the display screen.

Wherein a display content within the focused area at the first display resolution is controlled to display and a display content within the non-focused area at a second display resolution is controlled to display, comprises:

An original display content is received, and a first display content portion corresponding to the focused area and a second display content portion corresponding to the non-focused area based on the original display content are determined, a resolution of the first display content portion to the first display resolution and a resolution of the second display content portion to the second display resolution are adjusted, and the first display content portion with the first display resolution at the focused area on the display screen and the second display content portion with the second display resolution at the non-focused area are displayed on the display screen.

Wherein a resolution of the second display content portion to the second display resolution is adjusted, comprises:

An image data of the second display content portion is compressed to adjust the resolution of the second display content portion to the second display resolution; or an image data of the second display content portion is enlarged to adjust the resolution of the second display content portion to the second display resolution.

Wherein a first display content portion corresponding to the focused area and a second display content portion corresponding to the non-focused area are determined based on the original display content, comprises:

The resolution of the original display content is adjusted to be smaller than the pixel density and the first display content portion corresponding to the focused area and the second display content portion corresponding to the non-focused area are determined based on the original display content after a resolution adjustment.

In the embodiment of the present invention, an image having a different display resolution is transmitted to the focused area and the non-focused area, respectively, by sensing the focused area and the non-focus region on the display screen when the display screen is viewed by the human eye or an observing device, to make the first display resolution of the image displayed within the focused area is larger than the second display resolution of the image displayed within the non-focused area so as to ensure the image data amount of the focused area and the image data amount of the non-focused area is reduced, respectively. Since the focused area is the main field of view of the human eye or the observing device, the non-focused area belongs to the secondary field of view, and thus the respective images are separately processed for the focused area and the non-focused area, The picture quality of the main field of view is ensured, to ensure the overall display performance; but also reduce the total image data amount, reduce the display power consumption, reduce product heat, enhance product endurance.

### BRIEF DESCRIPTION OF THE DRAWINGS

In order to more clearly illustrate the embodiments of the present application or the technical solutions in the conventional art, the following drawings, which are to be used in the description of the embodiments or the conventional art, will be briefly described. It will be apparent that the drawings in the following description are some embodiments of the present application, and other drawings may be obtained by those skilled in the art without departing from the inventive work.

FIG. 1 is a schematic block diagram of a terminal device according to an embodiment of the present application;

FIG. 2 is a schematic flow chart of a display method of the embodiment of the present application.

### DETAILED DESCRIPTION OF THE PREFERRED EMBODIMENTS

The technical solutions in the embodiments of the present application will be described in detail below in connection with the drawings in the embodiments of the present application.

The following embodiments of the present application provide a terminal device including, but not limited to, a mobile terminal device, a desktop terminal device, etc., such as a mobile phone, a tablet computer, a desktop computer, and the like.

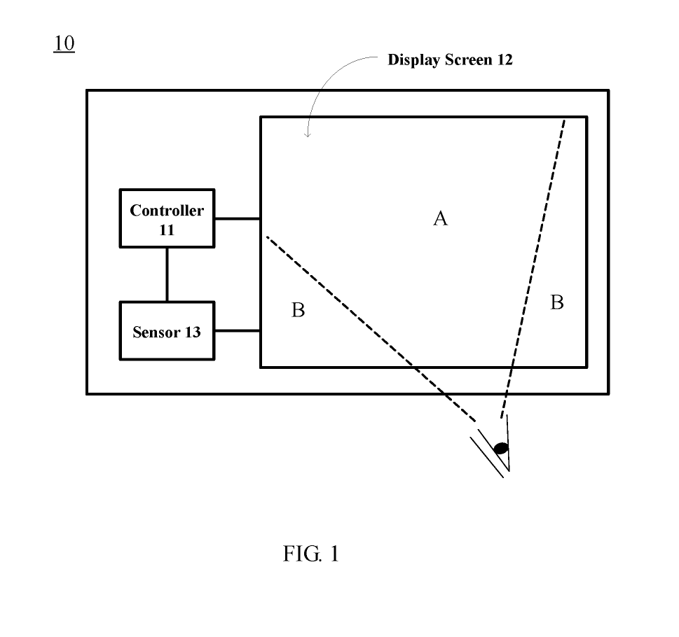

As shown in FIG. 1, in the embodiment of the present application, a terminal apparatus 10 comprises a sensor 13, a controller 11, and a display screen 12. The sensor 13 is used to sense a focused area A and a non-focused area B on the display screen 13 when the human eye or an observing device views the display screen 13. The controller 11 is used to display a display content within the focused area A at a first display resolution and to display a display content within the non-focused area B at a second display resolution, based on a sensing result of the sensor 13, wherein the first display resolution is higher than the second display resolution.

Wherein the observing device may refer to a device capable of scanning the image of the display screen 12 to pick up information, such as a camera. The observing device has a set scanning range, and image information within the scanning range is derived by one scanning. For the observing device, the focused area A is the area defined by the scanning range on the display screen 12, and the non-focused area B is the area outside the scanning range on the display screen 12 (i.e., the area outside the focused area A). The human eye also has a range of viewing angle, in the case of not rotating the eyes; the human eye can only be observed the image within the range of angles. Moreover, the human eye is the same as the camera with a visual focus, in the range of viewing angle, the closer to the focus of viewing angle; the clearer the picture is seen. Therefore, for the human eye, the focused area A is an area within the range of viewing angle and/or the area around the visual focus; the non-focusing area B is an area other than the range of viewing angle or an area farther from the visual focus. How to determine the visual focus and define the area near the visual focus or distant areas can be set, according to the relevant principles of human-machine engineering and the actual needs. In FIG. 1, the subject is the human eye, the area between the two dashed lines is the focused area A, and the remaining area is the non-focused area B, which is merely a representation. In fact, the observation body may be the observing device. The size, shape, and position distribution of the focused area A and the non-focused area B on the display screen 12 may be divided according to the specific situation, and is not limited to FIG. 1.

Specifically, the sensor 13 can determine the focused area A and the non-focusing area B by detecting the field of view of the human eye or the observing device when the human eye or the observing device views the display screen 12. For example, the sensor 13 may acquire the real-time operating position and the inherent scanning range of the observing device, to determine the position of the scanning sightline of the observing device according to the two parameters, and the scanning sightline is corresponded to the display screen 12 to define the focused area A and the non-focused area B. For example, the sensor 13 may acquire parameters such as the physiological parameters of the human eye and the position of the human eye relative to the screen so as to measure the range of viewing angle of the human eye and the scanning sightline of the human eye is corresponded onto the display screen 12 to define the focused area A and the non-focused area B.

The sensor 13 includes, but is not limited to, an infrared sensing module. Depending on the actual needs, the sensor 13 may be mounted at a corresponding position of the terminal apparatus 10 to sense the sightline of the human eye or the observing device.

The display screen 12 of the present embodiment includes, but is not limited to, a display device capable of displaying an image for a liquid crystal display panel, an OLED display screen, an ink screen, or the like. After the manufacturing is completed, the display screen 12 has a fixed pixel density (Pixels Per Inch, referred to as PPI). The pixel density is dependent on the type of the actual product.

The controller 11 is a control center of the terminal apparatus 10. The controller 11 can control the display screen 12 to display images of different display resolutions (i.e., different picture quality) in the focused area A and the non-focused area B, respectively, based on the sensing result of the sensor 13.

Specifically, under the control of the controller 11, the first display resolution of the display screen 12 displayed in the focused area A is greater than the second display resolution of the image displayed in the non-focused area B. That is, an image showing a higher display resolution (i.e., higher picture quality) is displayed in the focused area A while an image of a lower display resolution (i.e., lower picture quality) is displayed in the non-focused area B.

The number of dots characterizes the amount of image data. For example, an image with 1440*2562 dots occupies an image data volume of 1440*2562*3*8 bit. In the present embodiment, the image of the higher display resolution is displayed in the focused area A, and the non-focused area B is displayed with an image having a lower display resolution, that is, in unit area, the number of dots in the focused area A is larger than that of the non-focused region B, to ensure the image data volume of the focused area and lower the image data volume of the non-focused area B. Since the focused area A is the main field of view of the human eye or the observing device and the non-focusing area B belongs to the secondary field of view, the images shown in the focused area A and the non-focused area B are performed with different processes, both to ensure that the main field of view of the picture quality and to ensure the overall display performance; but also reduce the total amount of image data volume, reducing the power consumption of the display 12, reducing the product heat, enhance product endurance.

In the embodiment, the first display resolution is less than or equal to the pixel density of the display screen. In the situation that the first display resolution is equal to the pixel density, in the unit area of the focused area A; the number of dots is equal to the inherent pixel number of the display screen 12. Meanwhile, the focused area A is displayed in accordance with the quality of the original image. In the situation that the first display resolution is less than the pixel density, in the unit area of the focused area A; the number of dots is less than the inherent pixel number of the display screen 12. Meanwhile, the focused area A is not displayed in accordance with the quality of the original image, but with image compression. In the first case described above, it is possible to ensure that the focused area A has the image quality of the original image, and in the second case, the amount of image data is further reduced by compressing the image quality, thereby reducing the total image data amount and reducing the power consumption of the display screen 12.

Correspondingly, the second display resolution is always less than the pixel density of the display screen. That is, the image displayed in the non-focused area B is performed with image quality compression.

Furthermore, the controller 11 displays a display content within the focused area A at the first display resolution and a display content within the non-focused area B at a second display resolution. Specifically, it is performed as below:

The controller 11 receives an original display content, and determines a first display content portion corresponding to the focused area A and a second display content portion corresponding to the non-focused area B based on the original display content, adjusts a resolution of the first display content portion to the first display resolution and a resolution of the second display content portion to the second display resolution. Then, the controller 11 displays the first display content portion with the first display resolution at the focused area A on the display screen and the second display content portion with the second display resolution at the non-focused area B on the display screen.

Specifically, the controller 11 determines a first display content portion and a second display content portion based on the original display content. Specifically, it is performed as below:

The controller 11 may separate the first display content portion and the second display content portion directly from the original display content. In this manner, the original display content is the original image quality, and the display resolutions of the first display content portion and the second display content portion are adjusted on the basis of the original image quality.

Or, the controller 11 may adjust the display resolution of the original display content to be smaller than the pixel density, and then separate the first display content portion and the second display content portion from the original display content. In this manner, the controller 11 performs the image quality compression on the original display content in advance, thereby reducing the total amount of image data and reducing the power consumption of the display screen 12. Then, the display resolutions of the first display content portion and the second display content portion are adjusted separately on the basis of the overall image quality compression of the original display content. This method can further reduce the total amount of image data and reduce the power consumption of the display screen 12 as compared with the first method described above.

Specifically, the controller 11 adjusts a resolution of the second display content portion to the second display resolution, it is performed as below:

The controller 11 compresses an image data of the second display content portion to adjust the resolution of the second display content portion to the second display resolution; or the controller 11 enlarges (upscaling technique) an image data of the second display content portion to adjust the resolution of the second display content portion to the second display resolution. With the image compression or upscaling technique, the controller 11 can reduce the amount of image data of the image displayed within the non-focused area B. The above two kinds of image processing methods have speed data processing, efficiency, and mature usage. Of course, the controller 11 may also reduce the amount of image data of the image displayed within the non-focused area B in other manners.

In the present embodiment, the controller 11 may likewise adjust the resolution of the original display content and the first display content portion by using the above-described image processing method. For example, the controller 11 may use image compression or upscaling techniques to adjust the resolution of the original display content to less than the pixel density.

The terminal apparatus of the embodiment of the present application is described in detail above. The display method of the embodiment of the present application will be described below.

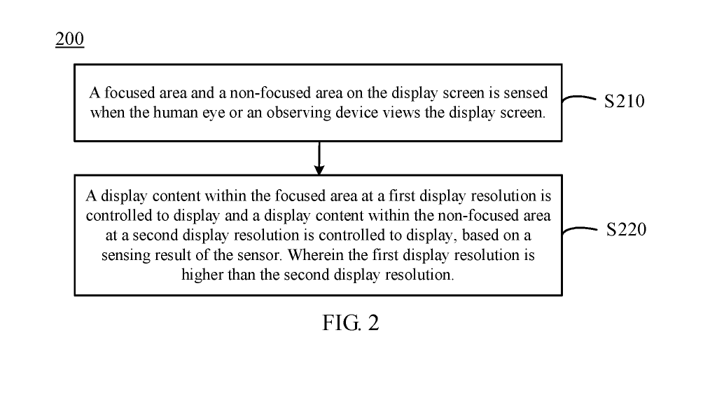

As shown in FIG. 2, an embodiment of the present application provides a display method 200 for displaying an image on a display screen of a terminal apparatus. The terminal apparatus may be the terminal apparatus 10 of the above-described embodiment, and the display screen may be the display screen 12 of the terminal apparatus 10. The display method 200 includes:

S210, a focused area and a non-focused area on the display screen is sensed when the human eye or an observing device views the display screen.

S220, a display content within the focused area at a first display resolution is controlled to display and a display content within the non-focused area at a second display resolution is controlled to display, based on a sensing result of the sensor. Wherein the first display resolution is higher than the second display resolution.

Specifically, the sensor 13 can determine the focused area A and the non-focusing area B by detecting the field of view of the human eye or the observing device when the human eye or the observing device views the display screen 12. For example, the sensor 13 may acquire the real-time operating position and the inherent scanning range of the observing device, to determine the position of the scanning sightline of the observing device according to the two parameters, and the scanning sightline is corresponded to the display screen 12 to define the focused area A and the non-focused area B. For example, the sensor 13 may acquire parameters such as the physiological parameters of the human eye and the position of the human eye relative to the screen so as to measure the range of viewing angle of the human eye and the scanning sightline of the human eye is corresponded onto the display screen 12 to define the focused area A and the non-focused area B.

The controller 11 can control the display screen 12 to display images of different display resolutions (i.e., different image quality) in the focused area A and the non-focused area B, respectively, based on the sensing result of the sensor 13. Specifically, under the control of the controller 11, the first display resolution of the display screen 12 displayed within the focused area A is greater than the second display resolution of the image displayed within the non-focused area B. That is, an image showing a higher display resolution (i.e., higher image quality) is displayed in the focused area A while an image of a lower display resolution (i.e., lower image quality) is displayed in the non-focused area B.

The number of dots characterizes the amount of image data. For example, an image with 1440*2562 dots occupies an image data volume of 1440*2562*3*8 bit. In the present embodiment, the image of the higher display resolution is displayed in the focused area A, and the non-focused area B is displayed with an image having a lower display resolution, that is, in unit area, the number of dots in the focused area A is larger than that of the non-focused region B, to ensure the image data volume of the focused area and lower the image data volume of the non-focused area B. Since the focused area A is the main field of view of the human eye or the observing device and the non-focusing area B belongs to the secondary field of view, the images shown in the focused area A and the non-focused area B are performed with different processes, both to ensure that the main field of view of the picture quality and to ensure the overall display performance; but also reduce the total amount of image data volume, reducing the power consumption of the display 12, reducing the product heat, enhance product endurance.

In S220, the first display resolution is less than or equal to the pixel density of the display screen. In the situation that the first display resolution is equal to the pixel density, in the unit area of the focused area A; the number of dots is equal to the inherent pixel number of the display screen 12. Meanwhile, the focused area A is displayed in accordance with the quality of the original image. In the situation that the first display resolution is less than the pixel density, in the unit area of the focused area A; the number of dots is less than the inherent pixel number of the display screen 12. Meanwhile, the focused area A is not displayed in accordance with the quality of the original image, but with image compression. In the first case described above, it is possible to ensure that the focused area A has the image quality of the original image, and in the second case, the amount of image data is further reduced by compressing the image quality, thereby reducing the total image data amount and reducing the power consumption of the display screen 12.

Correspondingly, the second display resolution is always less than the pixel density of the display screen. That is, the image displayed in the non-focused area B is performed with image quality compression.

Furthermore, in S220, the control of a display content within the focused area A at the first display resolution and the control of a display content within the non-focused area B at a second display resolution, which comprises:

An original display content is received. A first display content portion corresponding to the focused area A and a second display content portion corresponding to the non-focused area B are determined, based on the original display content. A resolution of the first display content portion to the first display resolution and a resolution of the second display content portion to the second display resolution are adjusted. Then, the first display content portion with the first display resolution at the focused area A on the display screen and the second display content portion with the second display resolution at the non-focused area B are displayed on the display screen.

Wherein that a first display content portion and a second display content portion are determined based on the original display content may comprises:

The first display content portion and the second display content portion may be separated directly from the original display content. In this manner, the original display content is the original image quality, and the display resolutions of the first display content portion and the second display content portion are adjusted on the basis of the original image quality.

Or, the display resolution of the original display content may be adjusted to be smaller than the pixel density, and then the first display content portion and the second display content portion are separated from the original display content. In this manner, the controller 11 performs the image quality compression on the original display content in advance, thereby reducing the total amount of image data and reducing the power consumption of the display screen 12. Then, the display resolutions of the first display content portion and the second display content portion are adjusted separately on the basis of the overall image quality compression of the original display content. This method can further reduce the total amount of image data and reduce the power consumption of the display screen 12 as compared with the first method described above.

Furthermore, in S220, wherein that resolution of the second display content portion is adjusted to the second display resolution can comprise:

An image data of the second display content portion is compressed to adjust the resolution of the second display content portion to the second display resolution;

Or an image data of the second display content portion is enlarged (upscaling technique) to adjust the resolution of the second display content portion to the second display resolution.

With the image compression or upscaling technique, the amount of image data of the image displayed within the non-focused area B can be reduced. The above two kinds of image processing methods have speed data processing, efficiency, and mature usage. Of course, the controller 11 may also reduce the amount of image data of the image displayed within the non-focused area B in other manners.

In the present embodiment, it is possible to adjust the resolution of the original display content and the first display content portion by using the above-described image processing method. For example, image compression or upscaling techniques can be used to adjust the resolution of the original display content to less than the pixel density.

It is to be understood that each of the execution bodies in the display method of the embodiment of the present application may correspond to the respective modules in the terminal apparatus of the embodiment of the present application, and the corresponding processes of the display method are completed by the respective modules in the terminal device and the above and other operations and/or functions. For the sake of simplicity, it will not be repeated here.

The foregoing is intended only as specific embodiments of the present application, but the scope of protection of the present application is not limited thereto and it will be readily apparent to those skilled in the art that various equivalents may be readily apparent to those skilled in the art, these modifications or substitutions, which should be within the scope of the present application. Accordingly, the scope of protection of the present application is subject to the scope of protection of the claims.

What is claimed is:

1. A terminal apparatus, comprising:
a sensor, a controller, and a display screen; the sensor being used to sense a focused area and a non-focused area on the display screen when the human eye or an observing device views the display screen; the controller being used to display a display content within the focused area at a first display resolution and to display a display content within the non-focused area at a second display resolution, based on a sensing result of the sensor, wherein the first display resolution is higher than the second display resolution.

2. The terminal apparatus according to claim 1, wherein the first display resolution is less than or equal to the pixel density of the display screen.

3. The terminal apparatus according to claim 1, wherein the controller that is used to display a display content within the focused area at the first display resolution and to display a display content within the non-focused area at a second display resolution, comprises:
the controller receives an original display content, and determines a first display content portion corresponding to the focused area and a second display content portion corresponding to the non-focused area based on the original display content, adjusts a resolution of the first display content portion to the first display resolution and a resolution of the second display content portion to the second display resolution, and display the first display content portion with the first display resolution at the focused area on the display screen and the second display content portion with the second display resolution at the non-focused area on the display screen.

4. The terminal apparatus according to claim 2, wherein the controller that is used to display a display content within the focused area at the first display resolution and to display a display content within the non-focused area at a second display resolution, comprises:
the controller receives an original display content and determines a first display content portion corresponding to the focused area and a second display content portion corresponding to the non-focused area, adjusts a resolution of the first display content portion to the first display resolution and a resolution of the second display content portion to the second display resolution, and display the first display content portion with the first display resolution at the focused area on the display screen and the second display content portion with the second display resolution at the non-focused area on the display screen, based on the original display content.

5. The terminal apparatus according to claim 3, wherein the controller that adjusts a resolution of the second display content portion to the second display resolution, comprises:
the controller compresses an image data of the second display content portion to adjust the resolution of the second display content portion to the second display resolution; or
the controller enlarges an image data of the second display content portion to adjust the resolution of the second display content portion to the second display resolution.

6. The terminal apparatus according to claim 4, wherein the controller that adjusts a resolution of the second display content portion to the second display resolution, comprises:
the controller compresses an image data of the second display content portion to adjust the resolution of the second display content portion to the second display resolution; or
the controller enlarges an image data of the second display content portion to adjust the resolution of the second display content portion to the second display resolution.

7. The terminal apparatus according to claim 3, wherein the controller that determines a first display content portion corresponding to the focused area and a second display content portion corresponding to the non-focused area based on the original display content, comprises:
the controller adjusts the resolution of the original display content to be smaller than the pixel density and determines the first display content portion corresponding to the focused area and the second display content portion corresponding to the non-focused area based on the original display content after a resolution adjustment.

8. The terminal apparatus according to claim 4, wherein the controller that determines a first display content portion corresponding to the focused area and a second display content portion corresponding to the non-focused area based on the original display content, comprises:
the controller adjusts the resolution of the original display content to be smaller than the pixel density and determines the first display content portion corresponding to the focused area and the second display content portion corresponding to the non-focused area based on the original display content after a resolution adjustment.

9. A display method, comprising:
sensing a focused area and a non-focused area on the display screen when the human eye or an observing device views the display screen;
controlling for displaying a display content within the focused area at a first display resolution and controlling for displaying a display content within the non-focused area at a second display resolution, based on a sensing result of the sensor, wherein the first display resolution is higher than the second display resolution.

10. The display method according to claim 9, wherein the first display resolution is less than or equal to the pixel density of the display screen.

11. The display method according to claim 9, wherein in the step of controlling for displaying a display content within the focused area at the first display resolution and controlling for displaying a display content within the non-focused area at a second display resolution, comprises:
receiving an original display content, and determining a first display content portion corresponding to the focused area and a second display content portion corresponding to the non-focused area based on the original display content, adjusting a resolution of the first display content portion to the first display resolution and a resolution of the second display content portion to the second display resolution, and displaying the first display content portion with the first display resolution at the focused area on the display screen and the second display content portion with the second display resolution at the non-focused area on the display screen.

12. The display method according to claim 10, wherein in the step of controlling for displaying a display content within the focused area at the first display resolution and controlling for displaying a display content within the non-focused area at a second display resolution, comprises:
receiving an original display content and determining a first display content portion corresponding to the focused area and a second display content portion corresponding to the non-focused area, adjusting a resolution of the first display content portion to the first display resolution and a resolution of the second display content portion to the second display resolution, and displaying the first display content portion with the first display resolution at the focused area on the display screen and the second display content portion with the second display resolution at the non-focused area on the display screen, based on the original display content.

13. The display method according to claim 11, wherein in the step of adjusting a resolution of the second display content portion to the second display resolution, comprises:
compressing an image data of the second display content portion to adjust the resolution of the second display content portion to the second display resolution; or
enlarging an image data of the second display content portion to adjust the resolution of the second display content portion to the second display resolution.

14. The display method according to claim 12, wherein in the step of adjusting a resolution of the second display content portion to the second display resolution, comprises:
compressing an image data of the second display content portion to adjust the resolution of the second display content portion to the second display resolution; or
enlarging an image data of the second display content portion to adjust the resolution of the second display content portion to the second display resolution.

15. The display method according to claim 11, wherein in the step of determining a first display content portion corresponding to the focused area and a second display content portion corresponding to the non-focused area based on the original display content, comprises:
adjusting the resolution of the original display content to be smaller than the pixel density and determining the first display content portion corresponding to the focused area and the second display content portion corresponding to the non-focused area based on the original display content after a resolution adjustment.

16. The display method according to claim 12, wherein in the step of determining a first display content portion corresponding to the focused area and a second display content portion corresponding to the non-focused area based on the original display content, comprises:
adjusting the resolution of the original display content to be smaller than the pixel density and determining the first display content portion corresponding to the focused area and the second display content portion corresponding to the non-focused area based on the original display content after a resolution adjustment.
